(19) United States
(12) Patent Application Publication
(10) Pub. No.: US 2010/0292355 A1
(43) Pub. Date: Nov. 18, 2010

(54) ALKENYL-AROMATIC FOAM HAVING GOOD SURFACE QUALITY, HIGH THERMAL INSULATING PROPERTIES AND LOW DENSITY

(76) Inventors: Mark A. Barger, Midland, MI (US); Charles A. Berglund, Durango, CO (US); Clive P. Bosnyak, Dripping Springs, TX (US); Stephanie A. Donati, Westerville, OH (US); John Gordon-Duffy, La Wantzenau (FR); Warren H. Griffin, Saginaw, MI (US); Ing-Feng Hu, Midland, MI (US); Jean-Francois Koenig, Strasbourg (FR); Simon Lee, Midland, MI (US); Creston D. Shmidt, Midland, MI (US); Roy E. Smith, Midland, MI (US); Chau V. Vo, Souffelweyersheim (FR)

Correspondence Address: The Dow Chemical Company, P.O. BOX 1967, Midland, MI, 48641, US

(21) Appl. No.: 12/596,178

(22) PCT Filed: Apr. 18, 2008
(86) PCT No.: PCT/US08/60709

§ 371 Date: Oct. 16, 2009

Related U.S. Application Data
(60) Provisional application No. 60/930,292, filed on May 15, 2007.
(60) Provisional application No. 60/958,201, filed on Jul. 3, 2007.

(51) Int. Cl. C08J 9/04; C08J 9/00

(52) U.S. Cl. 521/81; 521/139

(57) ABSTRACT

Prepare an alkenyl-aromatic foam having good surface quality, high thermal insulating properties and low density using an extrusion method by expanding a foamable polymer composition of an alkenyl-aromatic polymer composition containing less than 20 weight-percent covalently bonded halogens and having a polydispersity of less than 2.5 and a water solubility greater than 0.09 moles per kilogram and 2.2 moles per kilogram or less at 130 degrees Celsius and 101 kilopascals pressure and 0.8-2 moles per kilogram of a blowing agent containing 0.4 moles per kilogram or more of a chlorine-free fluorinated blowing agents and water at a concentration of at least 0.22 moles per kilogram; wherein moles per kilogram are relative to kilograms of alkenyl-aromatic polymer. The resulting foam has a density of 64 kilograms per cubic meter or less and a thermal conductivity of 32 milliwatts per meter-Kelvin or less after 180 days.

### CROSS REFERENCE STATEMENT

This application claims the benefit of U.S. Provisional Application No. 60/930,292 and U.S. Provisional Application No. 60/958,201, filed May 15, 2007 and Jul. 3, 2007, respectively.

### BACKGROUND OF THE INVENTION

1. Field of the Invention

The present invention relates to a thermoplastic polymer foam containing a alkenyl-aromatic polymer and a process for preparing such a foam.

2. Description of Related Art

Increasingly, regulations are restricting use of chlorinated blowing agents in preparing polymer foam. Chlorinated blowing agents are desirable for their role as blowing agents as well as for their contribution to a foam's thermal insulation capability. Chlorinated blowing agents having low thermal conductivities and which reside within foam cells for a relatively long period of time provide a long term thermal insulation capability. As a result, foams containing such chlorinated blowing agents can provide a long term thermal insulation capability. Identifying an alternate to chlorinated blowing agents for styrenic foams has been a topic of much research. Alternate blowing agents will desirably be more environmentally friendly than chlorinated blowing agents while at the same time offer an insulating capability similar to chlorinated blowing agents.

Environmentally friendly blowing agent candidates have included natural gases, particularly carbon dioxide. Carbon dioxide is attractive as a naturally occurring atmospheric gas. However, carbon dioxide lacks the thermal insulating properties of halogenated blowing agents. Moreover, carbon dioxide has low solubility in most styrenic polymers, manifest by a tendency to rapidly expand during foaming. Carbon dioxide often results in an undesirably irregular foam surface as, for example, the blowing agent rapidly erupts through the foam surface during the foaming process. Carbon dioxide also tends to cause small cell sizes and high foam density due to excessive rates of nucleation.

Water is perhaps an ideal environmentally friendly blowing agent because it is inexpensive, safe to the environment and easy to handle. Water, as with carbon dioxide, lacks the thermal insulating ability of halogenated blowing agents and has a low solubility in polystyrene. Water is known to produce blowholes (also known as pinholes) and/or bimodal cell structure in a polystyrene foam due to the low solubility of water in polystyrene. Blowholes (and pinholes) are voids the size of multiple cell diameters and easily observed by the naked eye.

U.S. Pat. No. 5,380,767 teaches that increasing the water solubility of the polymer tends to eliminate the blowholes (pinholes) and bimodal cell size structure when using water as a blowing agent. However, the challenge of simultaneously obtaining a long term thermal insulation value while obtaining good surface quality remains unsolved, even in U.S. Pat. No. 5,380,767.

European patent 1214372131 teaches that foaming a polymer having a polydispersity of 2.5 or more also facilitates use of water and carbon dioxide as a blowing agent by relieving processing difficulties associated with the low solubility blowing agents. Polydispersity is a ratio of weight average molecular weight (Mw) to number average molecular weight (Mn) and indicates the breadth of a polymer's molecular weight distribution (larger polydispersity corresponds to a broader molecular weight distribution). However, not all polymers are available with polydispersity of 2.5 or more.

Halogenated alternatives to chlorinated blowing agents that are more environmentally friendly than chlorinated blowing agents include chlorine-free fluorinated blowing agents such as hydrofluorocarbons (HFC) and fluorocarbons (FC). However, HFCs and FCs that have low thermal conductivities tend to suffer from one or more of the following undesirable characteristics: (a) tend to be too soluble in styrenic polymers and undesirably diminish final foam mechanical properties; (b) tend to be too insoluble in styrenic polymers and are undesirably problematic as blowing agents for similar reasons as with water and carbon dioxide; or (c) permeate out of the styrenic polymer foam so quickly that they do not contribute to long term thermal insulating properties of the polymer foam.

A further problem with foaming a polymer matrix using a blowing agent that has low solubility in the polymer matrix is that low density foam (64 kilograms per cubic meter or less) is difficult to achieve. Preparing a low density foam from a polymer matrix typically requires an amount of blowing agent that exceeds the blowing agent solubility in the polymer matrix, resulting in the problems already stated for carbon dioxide and water. Nonetheless, low density foam is desirable for insulating foams.

In view of the problems and desires in the present state of the art for low density thermally insulating foam, it is desirable to identify a process for preparing an alkenyl-aromatic polymer foam that simultaneously maximizes the environmentally friendly character of a blowing agent while producing a foam having a density of 64 kilograms per cubic meter (kg/m³) or less, a thermal conductivity of 32 milliWatt per meter-Kelvin (mW/m*K) or less after at least 180 days aging according to ASTM method C518 (that is, to have “long-term thermal insulation capability”), and a good surface quality while using a polymer having a polydispersity of less than 2.5.

### BRIEF SUMMARY OF THE INVENTION

The present Applicants have discovered a combination of polymer composition and blowing agent composition that is suitable for preparing an extruded alkenyl-aromatic polymer foam with a polymer having a polydispersity less than 2.5 and having a density of 64 kg/m³ or less, long-term thermal insulation capability (that is, a thermal conductivity of 32 mW/m*K or less according to American Society for Testing and Materials (ASTM) method C518 after at least 180 days), and a good surface quality using a blowing agent composition that contains water and a fluorinated compound.

Moreover, Applicants have unexpectedly discovered that the presence of an additive that produces ionic species in the presence of water exacerbates the challenge of achieving good surface quality in large scale extrusion processes. However, as a further embodiment of the present invention, Applicants have surprisingly discovered how to prepare an extruded alkenyl-aromatic polymer foam with a polymer having a polydispersity less than 2.5 and having a density of 64 kg/m³ or less, long-term thermal insulation capability (that is, a thermal conductivity of 32 mW/m*K or less according to American Society for Testing and Materials (ASTM) method C518 after at least 180 days), and a good surface quality using a blowing agent composition that contains water and a fluorinated compound even when the foam contains an additive that produces ionic species in the presence of water, even in large scale processes.

In a first aspect, the present invention is an extruded thermoplastic polymer foam comprising a polymer composition, wherein at least 70 weight-percent of the polymer composition is one or more alkenyl aromatic polymer that contains less than 20 weight-percent (wt %) covalently bonded halogen based on alkenyl-aromatic polymer weight and that has a polydispersity of less than 2.5 and wherein both the polymer composition and the one or more non-halogenated alkenyl aromatic polymer have a water solubility greater than 0.09 moles per kilogram (mol/kg) and 2.2 mol/kg or less at conditions of 130 degrees Celsius and 101 kilopascals (one atmosphere) pressure; the thermoplastic polymer foam characterized by having: (a) a density of 64 kilograms per cubic meter or less; (b) a thermal conductivity according to ASTM method C518-04 of 32 milliWatt per meter-Kelvin or less after at least 180 days aging; (c) one or more primary surface and a width, wherein 98% or more of any 200 square-centimeter portion of any primary surface of the foam that is centered on the foam's primary surface and extending to 80% of the foam's width free of defects; (d) less than 30% open cell content according to ASTM method D6226-05; and (e) a chlorine-free fluorinated blowing agent present at a concentration of 0.4 moles or more per kilogram of extruded thermoplastic polymer foam.

Preferred embodiments of the first aspect include one or more of the following further characteristics: the foam is free of chlorinated blowing agents; the alkenyl-aromatic polymer includes a styrene-acrylonitrile copolymer and, optionally, another alkenyl-aromatic polymer or copolymer; the alkenyl-aromatic polymer consists of a blend of one or more styrene-acrylonitrile copolymer and polystyrene; the chlorine-free fluorinated blowing agent comprises or is a blowing agent selected from 1,1,1,2-tetrafluoroethane and 1,1-difluoroethane; the chlorine-free fluorinated blowing agent is present at a concentration of 0.4 moles or more per kilogram of foam; further comprising an additive selected from a group consisting of insoluble lubricants and nucleating agents having an affinity for ions, particularly when the additive is selected from a group consisting of talc, oxidized polyethylene and boron nitride and wherein the polymer composition has a polydispersity of less than 2.5.

In a second aspect, the present invention is a process for preparing extruded thermoplastic polymer foam comprising: (a) providing a foamable polymer composition in an extruder, the foamable polymer composition comprising: (i) a polymer composition, wherein at least 70 weight-percent of the polymer composition is one or more alkenyl-aromatic polymer containing less than 20 wt % covalently bonded halogen based on alkenyl-aromatic polymer weight that has a polydispersity of less than 2.5 and wherein both the polymer composition and the one or more alkenyl-aromatic polymer have a water solubility greater than 0.09 moles per kilogram (mol/kg) and 2.2 mol/kg or less at conditions of 130 degrees Celsius and 101 kilopascals pressure; and (ii) 0.9-2 mol/kg of a blowing agent composition containing: (1) one or more chlorine-free fluorinated blowing agent at a concentration of 0.4 mol/kg or more; (2) water at a concentration of at least 0.15 mol/kg and up to the water solubility of the polymer composition or the balance of blowing agent beyond chlorine-free fluorinated blowing agent, whichever is less; and (3) one or more additional halogen-free blowing agent other than water accounting for any remaining blowing agent concentration; wherein mol/kg values are moles per kilogram of alkenyl-aromatic polymer; and (b) expanding the foamable polymer composition into a thermoplastic polymer foam having at least one primary surface, a density of 64 kilograms per cubic meter or less, a thermal conductivity of 32 milliWatt per meter-Kelvin or less after at least 180 days aging according to ASTM method C518-04, 98% or more of any 200 square-centimeter portion of any primary surface of the foam that is centered on the foam's primary surface and extending to 80% of the foam's width free of defects, and less than 30% open cell content according to ASTM method D6226-05.

Preferred embodiments of the second aspect include one or more of the following further characteristics: the blowing agent composition is free of chlorinated blowing agents; the alkenyl-aromatic polymer composition includes a styrene-acrylonitrile copolymer and, optionally, another alkenyl-aromatic polymer or copolymer; the alkenyl-aromatic polymer composition consists of a blend of a styrene-acrylonitrile copolymer and polystyrene; at least 80 weight-percent of the alkenyl-aromatic polymer consists of one or more styrene-acrylonitrile copolymer; the chlorine-free fluorinated blowing agent is a hydrofluorocarbon; the chlorine-free fluorinated blowing agent is one or more blowing agent selected from 1,1,1,2-tetrafluoroethane and 1,1-difluoroethane; the additional halogen-free blowing agent is carbon dioxide; the foamable composition further comprises an inorganic ion-producing additive; one more additional additive selected from a group consisting of insoluble lubricants and nucleating agents having an affinity for ions, particularly wherein the additional additive is selected from a group consisting of talc, oxidized polyethylene and boron nitride; and wherein the polymer composition has a polydispersity of less than 2.5.

In a third aspect, the present invention is a process for using the polymer foam of the first aspect comprising a step of placing the polymer foam between two areas.

### DETAILED DESCRIPTION OF THE INVENTION

### Terms

Polymer foams of the present invention comprise a polymer composition defining multiple cells. “Cells” are void spaces within the polymer composition. The polymer composition defines the cells with polymer films that serve as cell walls. A cell has more than one cell wall.

Polymer foams of the present invention have at least one “primary surface.” A primary surface is a surface having a planar surface area equal to the largest planar surface area of any surface of the polymer foam. Typically, a polymer foam of the present invention has two primary surfaces opposing one another (on opposing sides of the polymer foam). The opposing primary surfaces are generally parallel to one another. Primary surfaces typically comprise a polymer skin, or film, that extends over the primary surface.

A “planar surface area” is the surface area of a projection of a surface onto a plane. For example, a planar surface area of a rectangle is equal to its length times its width. Introduction of protrusions or depressions on a surface does not change a surface's planar surface area.

Polymer foams have mutually perpendicular length, width and thickness dimensions. A polymer foam's length dimension extends parallel to a polymer foam's extrusion direction. A polymer foam's thickness dimension is equal to or less than the polymer foam's width dimension.

A foam has a “good surface quality” if 98% or more, preferably 99% or more, still more preferably 99.5% or more, most preferably 100% of any 200 square-centimeter portion of any primary surface of the foam that is centered on the foam's primary surface and extending to 80% of the foam's width is free of defects. A “defect” is a discontinuity in polymer that provides access to more than one cell of the foam through a primary surface of the polymer foam. Defects are distinct from intentionally milled grooves or slices introduced into a foam after a foaming die.

A “quality foam” has a good surface quality, a density of 64 kilograms per cubic meter (kg/m³) or less, a thermal conductivity of 32 mW/m*K or less after at least 180 days and less than 30% open cell content. A quality foam desirably has one or more of the following additional characteristics: an average cell size of 0.1 millimeters or more, an average cell size of 2 millimeters or less and/or a monomodal cell size distribution.

A foam has a “monomodal cell size distribution” if a plot of number of cells versus cell size (rounded to nearest 0.05 millimeters (mm)) reveals one peak. In contrast, a foam having a multimodal cell size distribution reveals more than one peak in a similar plot. Measure at least 100 cells from a cut foam surface to create a plot for determining whether a foam is monomodal or multimodal. A peak occurs in such a plot at a given cell size if the population remains unchanged or continues to decrease for two immediately smaller and two immediately larger cell sizes adjacent to the given cell size.

“Large scale” process refers to a process producing an extruded polymer foam board using a mass flow rate through an extrusion die of greater than 25 kilograms per hour per centimeter of die width. Typically, extruded polymer foam board made by a large scale process has a width of at least 61 centimeters (24 inches).

“Small scale” process refers to a process for producing an extruded polymer foam board using a mass flow rate of 25 kilograms or less per hour per centimeter of die width.

“Die width” refers to the width of the exit opening in an extrusion die. Width is perpendicular to extrusion direction and is equal to or greater than the die gap. Die gap refers to a dimension mutually perpendicular to both die width and extrusion direction.

“Water solubility” of a polymer refers to moles of water soluble in a kilogram of polymer at 180 degrees Celsius and one atmosphere of pressure.

Open cell content refers to open cell content according to ASTM method D6226-05.

Density refers to density according to ISO method 845-85.

Thermal conductivity refers to thermal conductivity according to ASTM method C518.

Average cell size, or cell size, refers to average cell size according to ASTM method D-3756.

### Process for Producing a Thermoplastic Polymer Foam

In a first aspect, the present invention is a process for preparing extruded thermoplastic polymer foam.

The process comprises providing a foamable composition in an extruder and then expanding the foamable composition into a thermoplastic polymer foam. The process is an extrusion process that can be continuous or semi-continuous (for example, accumulative extrusion). In a general extrusion process, prepare a foamable composition of a thermoplastic polymer with a blowing agent in an extruder by heating a thermoplastic polymer composition to soften it, mixing a blowing agent composition together with the softened thermoplastic polymer composition at a mixing temperature and pressure that precludes expansion of the blowing agent to any meaningful extent (preferably, that precludes any blowing agent expansion) and then expelling the foamable composition through a die into an environment having a temperature and pressure below the mixing temperature and pressure. Upon expelling the foamable composition into the lower pressure the blowing agent expands the thermoplastic polymer into a thermoplastic polymer foam. Desirably, cool the foamable composition after mixing and prior to expelling it through the die. In a continuous process, expel the foamable composition at an essentially constant rate into the lower pressure to enable essentially continuous foaming.

Accumulative extrusion is a semi-continuous process that comprises: 1) mixing a thermoplastic material and a blowing agent composition to form a foamable polymer composition; 2) extruding the foamable polymer composition into a holding zone maintained at a temperature and pressure which does not allow the foamable polymer composition to foam; the holding zone having a die defining an orifice opening into a zone of lower pressure at which the foamable polymer composition foams and an openable gate closing the die orifice; 3) periodically opening the gate while substantially concurrently applying mechanical pressure by means of a movable ram on the foamable polymer composition to eject it from the holding zone through the die orifice into the zone of lower pressure, and 4) allowing the ejected foamable polymer composition to expand to form the foam. U.S. Pat. No. 4,323,528, herein incorporated by reference, discloses such a process in a context of making polyolefin foams, yet which is readily adaptable to aromatic polymer foam.

The foamable composition of the present process comprises a polymer composition that accounts for all of the components in the foamable polymer composition except the blowing agent. At least 70 weight-percent (wt %), preferably at least 80 wt %, more preferably at least 90 wt % of the polymer composition is one or more alkenyl aromatic polymer. 95 wt % or more, even 98 wt % or more, even 100 wt % of the polymer composition can be one or more alkenyl-aromatic polymer.

The one or more alkenyl-aromatic polymer contains less than 20 weight-percent (wt %), preferably 10 wt % or less, more preferably 5 wt % or less and most preferably zero wt % covalently bound halogen based on the weight of the alkenyl aromatic polymer. Notably, an alkenyl aromatic polymer containing 20 wt % or more covalently bonded halogens is considered “additional additive” in the scope of the present teaching and characterization of “alkenyl-aromatic polymer” herein does not include any additional additives. Desirably, the polymer composition is free from polymers having covalently bound halogens except of those qualifying as “additional additives”.

The one or more alkenyl-aromatic polymer, and desirably all of the polymer in the polymer composition, has a polydispersity of less then 2.5. Both the polymer composition and the one or more alkenyl-aromatic polymers have a water solubility greater than 0.09 moles per kilogram (mol/kg) and preferably 0.15 mol/kg or more. Typically, the polymer composition and the one or more alkenyl-aromatic polymers have a water solubility of 2.2 mol/kg or less. Values of mol/kg are based on a kilogram of thermoplastic alkenyl-aromatic polymer composition. Herein, water solubility refers to water solubility at 130 degrees Celsius (° C.) and at one atmosphere of pressure (101 kilopascals (kPa)).

Polystyrene homopolymer has a water solubility of about 0.08 mol/kg. Therefore, the polymer composition and non-halogenated alkenyl aromatic polymer(s) have a greater water solubility than polystyrene homopolymer at the same temperature and pressure. The benefit of using a polymer with higher water solubility than polystyrene homopolymer is that the present process may employ more water (hence, more ideal environmentally friendly blowing agent) in the blowing agent than is possible with polystyrene homopolymer, while still achieving a monomodal cell size distribution and a good surface quality.

Alkenyl-aromatic polymers contain multiple alkenyl-aromatic monomer units polymerized into a polymer structure. Suitable alkenyl-aromatic monomer units include styrene (vinyl benzene), alpha-methyl styrene, ethyl styrene, vinyl toluene, chlorostyrene and bromostyrene.

Suitable alkenyl-aromatic polymers include homopolymer of alkenyl-aromatic monomer units, copolymers containing alkenyl-aromatic monomer units (both graft and copolymerized copolymers) and blends of such homopolymers and/or copolymers with a miscible polymer that may or may not be an alkenyl-aromatic polymer (providing that at least 50 wt % of the alkenyl-aromatic polymer composition comprises one or more alkenyl-aromatic polymer). “Copolymers” includes random copolymers, alternating copolymers and block copolymers. “Copolymers” may be linear and branched.

In order to achieve a water solubility greater than 0.09 mol/kg at 130° C. and one atmosphere, the polymer composition contains polymers having monomer units that provide a greater water solubility than polystyrene homopolymer. That means the polymer composition does not consist entirely of polystyrene homopolymer. One of ordinary skill in the art can readily determine what monomer units achieve this result when copolymerized with an alkenyl-aromatic monomer. Examples of suitable copolymerizable monomers that enhance the water solubility of a styrene-based polymer when copolymerized with styrene include acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

Styrene-acrylonitrile copolymer (SAN) is a particularly desirable alkenyl-aromatic polymer for use in the present invention because of its ease of manufacture and monomer availability. The SAN copolymer can be a block copolymer or a random copolymer, and can be linear or branched. SAN provides not only a higher water solubility than polystyrene homopolymer, but also a higher heat distortion temperature. Desirable embodiments of the present process employ polymer compositions that comprise, even consist of SAN. The one or more alkenyl-aromatic polymer, even the polymer composition itself may comprise or consist of a polymer blend of SAN with another polymer such as polystyrene homopolymer.

Whether the polymer composition contains only SAN, or SAN with other polymers, the acrylonitrile (AN) component of the SAN is desirably present at a concentration of one wt % or more, preferably five wt % or more, more preferably ten wt % or more based on the weight of all polymers in the polymer composition. The AN component of the SAN is desirably present at a concentration of fifty wt % or less, typically thirty wt % or less based on the weight of all polymers in the polymer composition. When AN is present at a concentration of less than one wt %, the water solubility improvement is minimal over polystyrene unless another hydrophilic component is present. When AN is present at a concentration greater than fifty wt %, the polymer composition tends to suffer from thermal instability while in a melt phase in an extruder.

In a particularly preferred embodiment of the present invention, the polymer composition comprises a blend of two or more polymers having a solubility parameter difference between any two of them of 0.2 or more and, if the solubility parameter difference is greater than 0.4 then a compatibilizer is present to bring the effective solubility parameter difference to between 0.2 and 0.4. The solubility parameter difference is in units of (calories)^{0.5} per (milliliter)^{3/2} (that is, cal^{0.5}/cc^{3/2}) as calculated using the method of Small or Hoy (see, for example, J. Bandrup and E. H. Immergut, eds., POLYMER HANDBOOK, 4^{th} edition, Section VII, pages 683-714). The polymer that is present in the highest concentration forms a continuous phase and the remaining polymers form discrete domains in the continuous phase. A solubility difference of 0.2 to 0.4 ensures that the discontinuous polymer or polymers will form discrete domains of a suitably small size. The discrete domains each are of a size where at least one dimension of the discrete domain is up to (that is, equal to or less than) 25% of the thickness of a cell wall of the present foam. Such a particle size dimension is desirable to keep the discrete domains from rupturing the cell wall and causing the foam to increase in open cell content. It is further desirable for the higher solubility parameter polymer to be present at a lower concentration than the lower solubility parameter polymer and serve as the discrete phase. In this further desired form of this embodiment, the discrete phase enhances water and carbon dioxide solubility in the polymer composition thereby providing necessary water solubility while maintaining the rheology and lower cost of a less water soluble polymer.

Typically, the alkenyl-aromatic polymers in the polymer composition have a weight-average molecular weight (Mw) of 40,000 g/mol or more, preferably 60,000 g/mol or more, more preferably, 75,000 g/mol or more. The Mw of the polymers are also generally 300,000 g/mol or less, preferably 250,000 g/mol or less, and more preferably 150,000 g/mol or less. It is desirable for 90% or more, preferably all of the polymers in the polymer foam to have a Mw of less than 1,000,000 g/mol. If the polymer Mw is too low the polymer composition has insufficient physical strength to provide foam integrity. If the polymer Mw is too high, the gel viscosity of the polymer is so high that it is difficult to foam, particularly at economically attractive rates.

European patent 1214372B1 reveals that difficulties associated with blowing thermoplastic foam with water and carbon dioxide can be overcome by foaming a polymer composition having a polydispersity of 2.5 or more. Surprisingly, the process of the present invention can achieve quality foam using water and even water with carbon dioxide with a polymer composition having a polydispersity of less than 2.5. The alkenyl-aromatic polymer, and preferably all polymers in the polymer composition of the present invention, has a polydispersity of less than 2.5, and can be 2.3 or less or even 2.2 or less. Polydispersity is a ratio of weight average molecular weight (Mw) to number-average molecular weight (Mn) of a polymer.

The process of the present invention uses a blowing agent composition at a concentration of 0.9 to 2 mol/kg. Blowing agent concentration is expressed herein in terms of moles of blowing agent per kilogram of polymer composition (mol/kg). An objective of the present process is to provide a polymer foam having a density of 64 kg/m³ or less. In order to meet that objective the blowing agent should be present at a concentration of at least 0.9 mol/kg. Using more than 2 mol/kg of blowing agent generates a foam having such a low density that it tends to lack desirable mechanical strength.

The blowing agent composition contains a chlorine-free fluorinated blowing agent, at a concentration of 0.4 mol/kg or more. An objective of the present process is to produce a polymer foam having a thermal conductivity of 32 mW/m*K or less after at least 180 days aging according to ASTM method C518 (that is, to have “long-term thermal insulation capability”) with a concomitant objective of eliminating blowing agent that is detrimental to the environment. Chlorine-free fluorinated blowing agents are instrumental at achieving a long-term thermal insulation capability. Chlorine-free fluorinated blowing agents further provide long-term thermal insulation without suffering from the bad reputation of chlorinated blowing agents.

In order to achieve a long-term thermal insulation capability in an absence of any additional thermal insulating components (for example, infrared attenuator such as carbon black, graphite, titanium dioxide and metallic additives), the chlorine-free fluorinated blowing agent needs to be present at a concentration of at least 0.4 mol/kg based on polymer composition weight. Desirably, the chlorine-free fluorinated blowing agent is present at a concentration of 0.5 mol/kg or more, preferably 0.6 mol/kg or more, more preferably 0.65 mol/kg or more in order to maximize long-term thermal insulation capability. One of ordinary skill in the art recognizes that inclusion of insulating components in the foam reduces the amount of chlorine-free fluorinated blowing agent that is necessary to achieve long-term thermal insulating capability.

Suitable chlorine-free fluorinated blowing agents include difluoromethane (HFC-32), perfluoromethane, ethyl fluoride (HFC-161), 1,1,-difluoroethane (HFC-152a), 1,1,1-trifluoroethane (HFC-143a), 1,1,2,2-tetrafluoroethane (HFC-134), 1,1,1,2 tetrafluoroethane (HFC-134a), pentafluoroethane (HFC-125), perfluoroethane, 2,2-difluoropropane (HFC-272fb), 1,1,1-trifluoropropane (HFC-263fb), 1,1,1,2,3,3,3-heptafluoropropane (HFC-227ea), 1,1,1,3,3-pentafluoropropane (HFC-245fa), and 1,1,1,3,3-pentafluorobutane (HFC-365mfc). One particularly desirable chlorine-free fluorinated blowing agent is a combination of HFC-134a and HFC-152a. The HFC-134a serves as a particularly good long term thermal insulator while HFC-152a is particularly helpful at achieving good skin quality foam.

The chlorine-free fluorinated blowing agent may be present at a concentration up to a maximum amount set by a minimum amount of water present in the blowing agent composition.

Water is an ideal blowing agent in regards to environmental concerns. However, it has been challenging to effectively employ as a blowing agent in preparing thermoplastic foam due to its low solubility in polystyrene. The present process uses water at a concentration of at least 0.15 kg/mol, that is, above water solubility in polystyrene at 130° C. and one atmosphere pressure. The upper limit of water is defined by the water solubility of the polymer composition or the balance of blowing agent beyond the chlorine-free fluorinated blowing agent, whichever is less. If water is present above the water solubility of the polymer composition, the process will produce foam having blowholes (pinholes) and/or a multimodal cell size.

One or more additional halogen-free blowing agent, in addition to the water, accounts for any remaining balance of blowing agent not accounted for with water and the chlorine-free fluorinated blowing agent. Suitable halogen-free blowing agents include inorganic gases such as carbon dioxide, argon, nitrogen, and air; organic blowing agents such as aliphatic and cyclic hydrocarbons having from one to nine carbons including methane, ethane, propane, n-butane, isobutane, n-pentane, isopentane, neopentane, cyclobutane, and cyclopentane; aliphatic alcohols having from one to five carbons such as methanol, ethanol, n-propanol, and isopropanol; carbonyl containing compounds such as acetone, 2-butanone, and acetaldehyde; ether containing compounds such as dimethyl ether, diethyl ether, methyl ethyl ether; carboxylate compounds such as methyl formate, methyl acetate, ethyl acetate; carboxylic acid and chemical blowing agents such as azodicarbonamide, azodiisobutyronitrile, benzenesulfo-hydrazide, 4,4-oxybenzene sulfonyl semi-carbazide, p-toluene sulfonyl semi-carbazide, barium azodicarboxylate, N,N′-dimethyl-N,N′-dinitrosoterephthalamide, trihydrazino triazine and sodium bicarbonate.

In one desirable embodiment the blowing agent composition consists of HFC-134a and water. In another desirable embodiment, the blowing agent composition consists of HFC-134a, water and carbon dioxide, particularly where the carbon dioxide is present at a concentration up to that of the water.

The foamable composition, and hence the resulting polymer foam, can contain additional additives beyond a blowing agent. Additional additives include infrared attenuating agents such as carbon black, graphite, titanium dioxide and metal flake; filler such as talc and calcium carbonate; clays such as natural absorbent clays (for example, kaolinite and montmorillonite) and synthetic clays; flame retardants (for example, brominated flame retardants such as hexabromocyclododecane, phosphorous flame retardants such as triphenylphosphate, and combination flame retardant packages including synergists, brominated styrene-butadiene copolymers and other polymeric flame retardants); lubricants (for example, calcium stearate and barium stearate); and acid scavengers (for example, magnesium oxide and tetrasodium pyrophosphate). Alkenyl aromatic polymers containing 20 wt % or more covalently bonded halogens are additional additive within the scope of the present teachings and are not considered “alkenyl aromatic polymers” as characterized above. Additional additive may be present at concentrations up to 10 wt % based on total foamable composition weight.

An unexpected observation revealed that quality foam is particularly difficult to prepare in a large scale process when additives are present that produce inorganic ionic species in the presence of the water blowing agent (that is, inorganic ion-producing additives). Without being bound by theory, ionic species appear to modify the surface tension at the primary surface of a polymer foam during extrusion and expansion thereby weakening the surface during foam extrusion. Ions present at levels as low as 300 parts per million based on weight parts of polymer can be problematic. Production of polymer foam on a large scale (for example, at commercial production scale) exposes polymer foam surface to exceptionally high stress (relative to small scale processes such as pilot line scale production processes). Therefore, defects are likely to appear on a polymer foam's primary surface when ions are present during foaming, for example when inorganic ion-producing additives are present. Use of recycled material, tends to increase ion concentration, thereby exacerbating the problem of surface defects. Examples of inorganic ion-producing additives include brominated flame retardants (for example, hexabromocyclododecane), iron, phosphorous-containing compounds, sulfur-containing compounds, and inorganic salts.

Applicants have surprisingly discovered that the effect of inorganic ion-producing additives can be counteracted and foam having good skin quality can be prepared in a large scale process by including a nucleating agent that has an affinity for ions, particularly hydrophobic nucleating agents that have an affinity for ions (for example talc, graphite, carbon black) or inclusion of certain lubricants that are insoluble in the foamable composition (“insoluble lubricants”) such as oxidized polyethylene or boron nitride into a foamable polymer composition.

Nucleating agents having an affinity for ions are identifiable by having a higher concentration of ions proximate to them in a polymer foam matrix as compared to a portion of foam matrix remote from the nucleating agent when present in a polymer foam along with ions. Nucleating agents having an affinity for ions will have a higher concentration of ions within a five nanometer thick shell (a perimeter extending radially five nanometers from the surface of the nucleating agent) than portions of foam more remote (outside the five nanometer shell) from the nucleating agent. Determine concentration of ions by transmission electron microscopy accompanied by X-ray fluorescence analysis capability.

Large scale embodiments of the present process that include inorganic ion-producing additives further include one or more component selected from nucleating agents having an affinity for ions and insoluble lubricant, desirably at a concentration of at least 0.05 parts per hundred (based on polymer weight) in order to achieve foam having a good skin quality. Preferred embodiments that include inorganic ion-producing additives further include one or more component selected from talc, oxidized polyethylene and boron nitride.

The process of the present invention requires expanding the foamable composition into a thermoplastic polymer foam.

The expansion process typically involves expelling the foamable composition, typically through a foaming die, into an environment of lower pressure than the mixing pressure and allowing the foamable composition to expand into a closed cell polymer foam. Additional expansion is possible for the closed-cell foams of the present invention by exposing the polymer foam to steam or a vacuum for a period of time. The polymer foam, before and after any steam or vacuum expansion, is an alkenyl-aromatic polymeric foam that can be an aspect of the present invention.

### Alkenyl-Aromatic Polymer Foam

In a second aspect, the present invention is an extruded thermoplastic polymer foam (polymer foam). Polymer foams typically have a generally uniform polymer composition that serves as cell walls defining cells (spaces amongst the polymer composition that are free from polymer composition) The polymer foam of the present invention qualifies as a quality foam by having a good surface quality, a density of 64 kg/m3 or less, a thermal conductivity of 32 mW/m*K or less after at least 180 days, and less than 30% open cell content.

An extruded foam structure is distinct from, for example, expanded “bead” foam structures. Expanded bead foam structures contain bead skins throughout the foam structure that surround groups of foam cells within the polymer foam structure. The bead skins are relatively dense walls of polymer, relative to other cell walls, corresponding to the bead shell prior to expanding into a foam structure. The bead shells coalesce during molding to form a foam of multiple expanded foam beads having a coalesced bead skin network extending throughout the foam and enclosing groups of cells. Bead foams tend to be friable along the coalesced bead skin network. Extruded foam structures are free from bead skins and so tend to be less friable than bead foams. Extruded foams also desirably have a relatively uniform cell wall thickness throughout the foam. Notably, coalesced “strand” foams, foams of coalesced extruded strands of polymer foam, are types of extruded foam since they do not have bead skins that totally enclose groups of cells.

The extruded thermoplastic polymer foam comprises a polymer composition as described in regards to the process aspect of the present invention. Polymer foam of the present invention further comprises a chlorine-free fluorinated blowing agent as described above. The concentration of chlorine-free fluorinated blowing agent in the polymer foam is preferably 0.4 mol/kg or more, more preferably 0.5 mol/kg or more, still more preferably 0.6 mol/kg or more, even more preferably 0.65 mol/kg or more based on polymer composition weight. As is the case in the process aspect of the present invention, the polymer foam of the present invention is desirably free of chlorinated blowing agents.

If the extruded thermoplastic foam contains inorganic ion-producing additives it also desirably contains one or more than one additional additive selected from a group consisting of nucleating agents that have an affinity for ions (for example, talc) and lubricants that are insoluble in the polymer foam's polymer network during manufacture (for example, oxidized polyethylene and boron nitride). As taught above, these additional additives facilitate large scale manufacture of a quality foam that contains an inorganic ion-producing additive.

The extruded thermoplastic polymer foam has a density of 64 kilograms per cubic meter (kg/m³) or less, preferably 50 kg/m³ or less, more preferably 40 kg/m³ or less, still more preferably 35 kg/m³ or less. Lower density foams are desirable because they are better thermal insulators than higher density foams. Typically, the extruded thermoplastic polymer foam has a density greater than 24 kg/m³ in order to have sufficient mechanical strength to preclude collapse when handling and in use.

The extruded thermoplastic polymer foam has “long term thermal insulation capability,” which means that the polymer foam has a thermal conductivity of 32 mW/m*K or less after at least 180 days aging according to ASTM method C518. Desirably, the polymer foam has a thermal conductivity of 30 mW/m*K or less, preferably 28 mW/m*K or less after the same period of time according to the same test conditions and method.

The polymer foam desirably has an average cell size of 0.10 mm or greater, preferably 0.15 mm or greater, more preferably 0.2 mm or greater. Cells smaller than 0.10 mm are largely transparent to infrared radiation and, as a result, tend to be ineffective at inhibiting infrared transmittance through the foam. Cells larger than about 0.10 mm have a greater tendency to reflect infrared radiation and thereby contribute to the thermal insulating characteristics of the foam. Cell sizes are generally two mm or less, preferably one mm or less, more preferably 0.5 mm or less and still more preferably 0.4 mm or less. Cell sizes of greater than about 0.5 mm tend to allow convection of cell gasses, which reduces the thermal insulation property of the foam. Foams of the present invention also desirably have a monomodal cell size distribution.

The polymer foam is a closed cell foam in order to maximize retention of the chlorine-free fluorinated blowing agent, which enhances the long term thermal insulation capability of the foam. A closed cell foam has an open cell content of 30% or less, preferably 20% or less, more preferably 10% or less, even more preferably 5% or less, still more preferably 2% or less, most preferably 1% or less. The polymer foam can have an open cell content of 0%.

Another advantage of the present foam's closed cell structure is that the foam can undergo steam expansion. Steam expansion is a process through which a closed cell foam can be further expanded to reduce its density by exposure to steam. To steam expand a foam expose it to steam for a certain period of time. Vacuum expansion can also be useful to further expand and reduce the density of a polymer foam. Vacuum expand a closed-cell foam by exposing the foam to sub-atmospheric pressure for a period of time. Steam expansion and vacuum expansion are beneficial to achieve lower densities (for example, 23 kg/m³ or less, 20 kg/m³ or less, even 19 kg/m³ or less) than readily achievable by direct extrusion.

### Use of the Polymeric Foam

Foams of the present invention are particularly useful as thermal insulation, though the foam is also useful for many other applications. To use the foam as thermal insulation, place the foam between two areas. The polymer foam serves to thermally insulate one area from temperature changes in the other area.

### Examples

The following examples serve to further illustrate embodiments of the present invention rather than necessarily identify the full scope of the invention.

### Small Scale Examples

Prepare the following Examples (Exs) 1-4 and Comparative Examples (Comp Exs) A-C using a pilot scale extrusion foam process having a mass flow rate through an extrusion die of 18 kilograms per hour per centimeter die, width. Feed the polymer components and any additives into a 6.5 centimeter diameter extruder that feeds a rotary mixer. Add a blowing agent composition to the polymer components in the rotary mixer at a mixing temperature of 184° C. and mixing pressure of 18.7 megapascals in order to form a foamable composition. Cool the foamable composition with heat exchangers and then discharge through a slot die 5 centimeters wide by 1.9 millimeter gap at a die temperature and pressure (see Tables 1 and 2) and at a rate of approximately 90 kilograms per hour into atmospheric pressure and ambient temperature. The foamable composition then expands into a polymer foam. See Table 1 below for blowing agent composition, die temperature and pressure and foam properties.

For Examples 1 and 3, use a die lip temperature of 85° C. For Example 2 and Comparative Example A, use a die lip temperature of 90° C. For Example 4, use a die lip temperature of 60° C. For Comparative Example B, use a die lip temperature of 118° C. For Comparative Example C, use a die lip temperature of 130° C.

The polymer composition for Exs 1-4 is a styrene-acrylonitrile copolymer comprising a 50/50 blend of two SANs each having an AN concentration of 15 wt % and water solubility of 0.45 moles water per kilogram polymer at 185 kPa (corresponding to 0.25 mol/kg at one atmosphere pressure); one having an average Mw of 144,000 and the other having an average Mw of 118,000. Neither have a Mw component above 1,000,000. The polymer composition has a polydispersity of 2.2.

The polymer composition for Comp Ex A is a polystyrene homopolymer having a Mw of 168,000 g/mol and a water solubility of 0.10 moles water per kilogram of polymer at 123 kPa (corresponding to 0.08 mol/kg at one atmosphere pressure).

The polymer composition for Comp Ex B is a styrene-acrylonitrile copolymer (142,000 g/mol Mw, 2.2 Mw/Mn, 15 wt % AN based on polymer composition weight, water solubility of 0.45 moles water per kilogram polymer at 185 kPa (corresponding to 0.25 mol/kg at one atmosphere pressure)).

The polymer composition for Comp Ex C is a styrene-acrylonitrile copolymer comprising a blend of two SANs each having an AN concentration of 15 wt % and water solubility of 0.45 moles water per kilogram polymer at 185 kPa (corresponding to 0.25 mol/kg at one atmosphere pressure). The blend comprises 80 wt % of an SAN having an average Mw of 155,000 and 20 wt % of an SAN having an average Mw of 113,000. Neither have a Mw component above 1,000,000. The polymer composition has a polydispersity (Mw/Mn) of 2.2.

Table 1 shows the blowing agent composition, additive components and resulting foam characteristics for Exs 1-4 and Comp Exs A-C. Concentrations in “pph” are weight parts per hundred weight parts of polymer composition. Mol/kg is moles of blowing agent relative to kilogram of polymer composition. A “good” surface quality meets the definition set forth above for good surface quality. A “poor” surface quality does not meet the definition of “good surface quality” set forth above.

TABLE 1

| | Ex 1 | Ex 2 | Ex 3 | Ex 4 | Comp Ex A | Comp Ex B | Comp Ex C |
|---|---|---|---|---|---|---|---|
| H₂0 | 0.82 | 0.55 | 0.39 | 0.33 | 0.19 | 0.33 | 0.67 |
| (mol/kg) | | | | | | | |
| C0₂ | 0 | 0.2 | 0.4 | 0.36 | 0.11 | 0.44 | 0.77 |
| (mol/kg) | | | | | | | |
| 134a | 0.64 | 0.64 | 0.64 | 0.69 | 0.69 | 0.55 | 0.39 |
| (mol/kg) | | | | | | | |
| Isobutane | 0 | 0 | 0 | 0.21 | 0 | 0 | 0 |
| (mol/kg) | | | | | | | |
| HBCD^{a} | 0.9 | 0.9 | 0.9 | 0.9 | 2.6 | 0 | 1.3 |
| (pph) | | | | | | | |
| Antioxidant^{b} | 0.02 | 0.02 | 0.02 | 0.02 | 0 | 0.02 | 0 |
| (pph) | | | | | | | |
| Hydrotalcite DHT4A | 0.01 | 0.01 | 0.01 | 0.01 | 0 | 0.01 | 0 |
| (Acid Scavenger) | | | | | | | |
| (pph) | | | | | | | |
| Thermal Stabilizer^{c} | 0.02 | 0.02 | 0.02 | 0.02 | 0 | 0.02 | 0 |
| (pph) | | | | | | | |
| Barium Stearate | 0.15 | 0.15 | 0.15 | 0.15 | 0.2 | 0.25 | 0.1 |
| (pph) | | | | | | | |
| Tetrasodium | 0 | 0 | 0 | 0 | 0.2 | 0 | 0.1 |
| pyrophosphate | | | | | | | |
| (pph) | | | | | | | |
| Copper | 0.025 | 0.025 | 0.025 | 0.025 | 0.025 | 0.025 | 0.025 |
| phthalocyanine | | | | | | | |
| (pph) | | | | | | | |
| LLDPE^{d} | 0.3 | 0.3 | 0.3 | 0.3 | 0.4 | 0.6 | 0.2 |
| (pph) | | | | | | | |
| Talc | 0.4 | 0.15 | 0 | 0 | 0 | 0 | 0 |
| (pph) | | | | | | | |
| Die temp | 130 | 130 | 130 | 130 | 125 | 137 | 135 |
| (° C.) | | | | | | | |
| Die pressure (bars) | 72 | 72 | 72 | 72 | 70 | 75 | 87 |
| Density | 33.5 | 33.7 | 31.9 | 32.2 | 45.4 | 30.6 | 29.6 |
| (kg/m³) | | | | | | | |
| Cell Size | 0.31 | 0.23 | 0.25 | 0.21 | 0.13 | 0.18 | 0.17 |
| Open Cell Content | 0 | 0 | 0 | 0 | 49 | 46 | 1.1 |
| (%) | | | | | | | |
| Surface Quality | Good | Good | Good | Good | Poor | Poor | Good |
| Thermal | 28.9 | 28.0 | 28.1 | 27.6 | Not | 34.2 | 34.2 |
| Conductivity | | | | | Measured | | |
| (mW/m * K)^{e} | | | | | | | |
| Cell Size | Mono | Mono | Mono | Mono | Mono | Mono | Mono |
| Distribution | | | | | (with | | |
| (mono- or multi- | | | | | pinholes) | | |
| modal) | | | | | | | |

^{a}HBCD = hexabromocyclododecane
^{b}Antioxidant is NAUGUARD ™ XL1 (NAUGUARD is a trademark of Chemtura Corp.)
^{c}Thermal Stabilizer is THERMCHECK ™ 832
^{d}LLDPE = linear low density polyethylene. Concentration is in wt % relative to total polymer composition weight.
^{e}Measure using ASTM method C518-04 after 180 days

Exs 1-4 illustrate that a foam having good surface quality, monomodal cell size distribution, a density of less than 64 kg/m³, thermal conductivity of 32 mW/m*K or less, less than 1% open cell content is possible while using a blowing agent composition containing more water than is soluble in polystyrene homopolymer. In contrast, Comp Ex A illustrates that using a similar amount of water in polystyrene (thereby, exceeding the water solubility of the polymer) results in an open cell foam with small cell size and pinholes. While Comp Ex A includes more HBCD than Exs 1-4, the effect of the higher HBCD loading should be minor compared to the effect of using a different polymer with this loading of water.

Exs 1-4 also illustrate such a foam is achievable with a chlorine-free fluorinated blowing agent. Exs 1-4 further illustrate that such a foam is achievable while including a non-halogenated blowing agent in addition to water and a chlorine-free fluorinated blowing agent. Notably, Example 1 has a thermal conductivity of 29 mW/m*K even after 270 days and Example 4 has a thermal conductivity of 27.8 after 369 days.

Exs 1-3 illustrate that carbon dioxide can be included up to the concentration of water and still achieve a foam of the present invention. However, Comp Ex B illustrates that when the concentration of CO₂ exceeds that of water a foam outside the scope of the present invention results due to poor surface quality and, in this case, high open cell content.

Exs 3 and 4 illustrate that a quality foam containing an inorganic ion-producing additive (in this case, HBCD) may be prepared on a small scale pilot line scale without a nucleating agent having an affinity for ions or an insoluble lubricant.

Comparative Example C illustrates that less than 0.4 moles per kilogram of polymer composition provides a polymer foam having a thermal conductivity greater than 32 mW/m*K after 180 days.

### Large Scale Examples

Prepare Ex 5, Ex 6 and Comp Ex C using a production scale extrusion process running at 34 kilograms of polymer per hour per centimeter of die width. Prepare a foamable polymer composition in an extruder by melt blending a polymer, blowing agents and additives.

Table 2 shows the concentrations of each of the components in the foamable polymer composition. The polymer comprises 75 wt % virgin SAN copolymer (133,500 g/mol Mw with no fraction greater than 1,000,000 g/mol; 2.24 Mw/Mn; 15 wt % AN; and 40 grams per 10-minute melt flow rate per ASTM D1238-I) and 25 wt % recycle material from densified, extruded and pelletized polymer foam (same polymer foam as being made by the recycled polymer and rinsed using a closed loop water rinse process). The virgin SAN and recycled material constitute 100 weight-parts of polymer. Table 2 lists all remaining component concentrations relative to 100 weight parts of polymer (parts per hundred, or “pph”). Blend the polymer composition at a temperature of about 220° C. and at a pressure sufficient to preclude expansion.

Cool the polymer composition to a foaming temperature of about 134° C. and extrude at a die pressure of about 6.8 megapascals through a slit die with a gap of between one and two millimeters. The die has a lip temperature of about 75° C. Extrude into atmospheric pressure and allow to foam into a polymer foam board. Cool the foam board until the polymer solidifies.

Subject the solidified polymer foam board to steam for 40-60 seconds at 101° C. to further expand the foam and reduce its density. The resulting foam board has a thickness of 25 millimeters. Table 2 indicates the final foam properties for the resulting polymer foams.

TABLE 2

| Material/Property | Units | Ex 5 | Comp Ex C | Ex 6 |
|---|---|---|---|---|
| Polymer | pph | 100 | 100 | 100 |
| HFC-134a | pph | 7.5 | 7.5 | 7.5 |
| | (mol/kg polymer) | (7.5) | | |
| Carbon Dioxide | pph | 1.2 | 1.2 | 1.2 |
| | (mol/kg polymer) | (0.25) | | |
| Water | pph | 0.9 | 1.0 | 1.0 |
| | (mol/kg polymer) | (0.50) | | |
| Copper phthalocyanine | pph | 0.025 | 0.025 | 0.025 |
| HBCD | pph | 0 | 0.95 | 0.95 |
| Antioxidant^{a} | pph | 0.02 | 0.02 | 0.02 |
| Hydrotalcite DHT4A (Acid Scavenger) | pph | 0.01 | 0.01 | 0.01 |
| Thermal Stabilizer^{b} | pph | 0.02 | 0.02 | 0.02 |
| Barium Stearate | pph | 0.15 | 0.15 | 0.15 |
| Linear Low Density Polyethylene | pph | 0.3 | 0.3 | 0.3 |
| (LLDPE)^{c} | | | | |
| Talc^{d} | pph | 0 | 0 | 0.15 |
| Foam Density | kg/m³ | 26.5 | 27.9 | 27.0 |
| Average Cell Size | mm | 0.24 | 0.25 | 0.19 |
| Skin Quality | good/poor | good | poor | good |
| (% of 200 cm² portion of primary | | (>99.5) | (<98%) | (>99.5) |
| surface free of defects)^{e} | | | | |
| Thermal Conductivity | mW/m*K (per ASTM | 29.1 | 28.9 | 28.6 |
| | method C518 | | | |
| | after 180 days) | | | |
| Open Cell Content | % | 0 | 3 | 1 |
| Cell Size Distribution | mono- or multi- | Mono | Mono | Mono |
| | modal | | | |

^{a}Antioxidant is NAUGUARD ™ XL1 (NAUGUARD is a trademark of Chemtura Corp.)
^{b}Thermal Stabilizer is THERMCHECK ™ 832
^{c}LLDPE is used as a cell size modifier and is DOWLEX ™ 2047 (DOWLEX is a trademark of The Dow Chemical Company).
^{d}The talc is a coated talc sold under the name MISTRON ™ ZSC (MISTRON is a trademark of Luzenac America Inc.).
^{e}Measure skin quality on the 200 cm² portion of a primary surface containing most defects.

Ex 5 illustrates a production scale polymer foam and process for preparing that foam, both within the scope of aspects of the present invention, that does not include an inorganic ion-producing additive. The resulting foam has a good quality surface without requiring inclusion of a nucleating agent having an affinity for ions or an insoluble lubricant.

Comp Ex C illustrates a foam and process similar to Ex 4 except with 0.95 pph of hexbromocyclodocane (HBCD) present. Use, for example, SAYTEX™ H900 HBCD (SAYTEX is a trademark of Albemarle Corporation). HBCD is an inorganic ion-producing additive. The resulting foam has enough defects on its primary surface to preclude it from qualifying as having a good quality surface.

Ex 6 illustrates that a nucleating agent having an affinity for ions can counteract the detrimental effect an inorganic ion-producing additive has on a polymer foam's primary surface. Ex 6 is similar to Comp Ex C except 0.15 pph Talc is present in the foamable composition (and final foam). In contrast to Comp Ex C, the resulting foam has a good quality surface.

1. An extruded thermoplastic polymer foam comprising a polymer composition, wherein at least 70 weight-percent of the polymer composition is one or more alkenyl aromatic polymer that contains less than 20 wt % covalently bonded halogens based on alkenyl-aromatic polymer weight and that has a polydispersity of less than 2.5 and wherein both the polymer composition and the one or more alkenyl aromatic polymer have a water solubility greater than 0.09 moles per kilogram (mol/kg) and 2.2 mol/kg or less at conditions of 130 degrees Celsius and 101 kilopascals pressure; the thermoplastic polymer foam characterized by having:
(a) a density of 64 kilograms per cubic meter or less;
(b) a thermal conductivity according to ASTM method C518-04 of 32 milliWatt per meter-Kelvin or less after at least 180 days aging;
(c) one or more primary surface and a width, wherein 98% or more of any 200 square-centimeter portion of any primary surface of the foam that is centered on the foam's primary surface and extending to 80% of the foam's width free of defects;
(d) less than 30% open cell content according to ASTM method D6226-05; and
(e) a chlorine-free fluorinated blowing agent present at a concentration of 0.4 moles or more per kilogram of extruded thermoplastic polymer foam.

2. The foam of claim 1, wherein the foam is free of chlorinated blowing agents.

3. The foam of claim 1, wherein the alkenyl-aromatic polymer includes a styrene-acrylonitrile copolymer and, optionally, another alkenyl-aromatic polymer or copolymer.

4. The foam of claim 1, wherein the alkenyl-aromatic polymer consists of a blend of one or more styrene-acrylonitrile copolymer and polystyrene.

5. The foam of claim 1, wherein the chlorine-free fluorinated blowing agent comprises one or more blowing agent selected from 1,1,1,2-tetrafluoroethane and 1,1-difluoroethane.

6. The foam of claim 1, wherein the chlorine-free fluorinated blowing agent is one or more blowing agent selected from 1,1,1,2-tetrafluoroethane and 1,1-difluoroethane.

7. The foam of claim 1, wherein the chlorine-free fluorinated blowing agent is present at a concentration of 0.4 moles or more per kilogram of foam.

8. The foam of claim 1, further comprising an additive selected from a group consisting of insoluble lubricants and nucleating agents having an affinity for ions.

9. The foam of claim 8, wherein the additive is selected from a group consisting of talc, oxidized polyethylene and boron nitride.

10. The foam of claim 1, wherein the polymer composition has a polydispersity of less than 2.5.

11. A process for preparing extruded thermoplastic polymer foam comprising:
(a) providing a foamable polymer composition in an extruder, the foamable polymer composition comprising:
i. a polymer composition, wherein at least 70 weight-percent of the polymer composition is one or more alkenyl-aromatic polymer that contains less then 20 wt % covalently bonded halogens based on alkenyl-aromatic polymer weight and that has a polydispersity of less than 2.5 and wherein both the polymer composition and the one or more non-halogenated alkenyl-aromatic polymer have a water solubility greater than 0.09 moles per kilogram (mol/kg) and 2.2 mol/kg or less at conditions of 130 degrees Celsius and 101 kilopascals pressure; and
ii. 0.9-2 mol/kg of a blowing agent composition containing:
1. one or more chlorine-free fluorinated blowing agent at a concentration of 0.4 mol/kg or more;
2. water at a concentration of at least 0.15 mol/kg and up to the water solubility of the polymer composition or the balance of blowing agent beyond chlorine-free fluorinated blowing agent, whichever is less; and
3. one or more additional halogen-free blowing agent other than water accounting for any remaining blowing agent concentration;
wherein mol/kg values are moles per kilogram of alkenyl-aromatic polymer; and
(b) expanding the foamable polymer composition into a thermoplastic polymer foam having at least one primary surface, a density of 64 kilograms per cubic meter or less, a thermal conductivity of 32 milliWatt per meter-Kelvin or less after at least 180 days aging according to ASTM method C518-04, 98% or more of any 200 square-centimeter portion of any primary surface of the foam that is centered on the foam's primary surface and extending to 80% of the foam's width free of defects, and less than 30% open cell content according to ASTM method D6226-05.

12. The process of claim 11, wherein the blowing agent composition is free of chlorinated blowing agents.

13. The process of claim 11, wherein the alkenyl-aromatic polymer composition includes a styrene-acrylonitrile copolymer and, optionally, another alkenyl-aromatic polymer or copolymer.

14. The process of claim 11, wherein the alkenyl-aromatic polymer consists of a blend of a styrene-acrylonitrile copolymer and polystyrene.

15. The process of claim 11, wherein at least 80 weight-percent of the alkenyl-aromatic polymer composition consists of one or more styrene-acrylonitrile copolymer.

16. The process of claim 11, wherein the chlorine-free fluorinated blowing agent is a hydrofluorocarbon.

17. The process of claim 11, wherein the chlorine-free fluorinated blowing agent is one or more blowing agent selected from 1,1,1,2-tetrafluoroethane and 1,1-difluoroethane.

18. The process of claim 11, wherein the additional halogen-free blowing agent is carbon dioxide.

19. The process of claim 11, wherein the foamable composition further comprises an inorganic ion-producing additive and one more additional additive selected from a group consisting of insoluble lubricants and nucleating agents having an affinity for ions.

20. The process of claim 19, wherein the additional additive is selected from a group consisting of talc, oxidized polyethylene and boron nitride.

21. The process of claim 11, wherein the polymer composition has a polydispersity of less than 2.5.

22. A process for using the polymer foam of claim 1 comprising a step of placing the polymer foam between two areas.
